(19) United States
(12) Patent Application Publication
(10) Pub. No.: US 2020/0365101 A1
(43) Pub. Date: Nov. 19, 2020

(54) DISPLAY SUBSTRATE, DISPLAY PANEL AND DRIVING METHOD THEREOF

(71) Applicants: Hefei BOE Display Technology Co., Ltd., Anhui (CN); BOE TECHNOLOGY GROUP CO., LTD., Beijing (CN)

(72) Inventors: Yuntian ZHANG, Beijing (CN); Peng JIANG, Beijing (CN); Ke DAI, Beijing (CN); Haipeng YANG, Beijing (CN); Chunxu ZHANG, Beijing (CN); Zhonghou WU, Beijing (CN); Yafei DENG, Beijing (CN)

(21) Appl. No.: 16/957,707

(22) PCT Filed: Nov. 11, 2019
(86) PCT No.: PCT/CN2019/117131

§ 371 Date: Jun. 24, 2020

(30) Foreign Application Priority Data
Nov. 12, 2018 (CN) 201811340745.7

(51) Int. Cl. G09G 3/36; G09G 3/3275

(52) U.S. Cl. CPC G09G 3/3607; G09G 3/3685; G09G 2320/0626; G09G 3/3614; G09G 3/3275

(57) ABSTRACT

The present disclosure provides a display substrate, a display panel and a driving method thereof. The display substrate includes: a plurality of sub-pixels arranged in an array, the plurality of sub-pixels including sub-pixels of at least two colors, wherein for any two adjacent rows in the array, a color of the i-th sub-pixel in one row is the same as a color of the (i+1)-th sub-pixel in the other row, a color of the n-th sub-pixel in the one row is the same as a color of the first sub-pixel in the other row, where i is an integer greater than or equal to 1 and smaller than or equal to n, and n is a number of the sub-pixels in one row; and a plurality of data lines, each of which is coupled to sub-pixels of a same color in two adjacent columns of sub-pixels.

### TECHNICAL FIELD

The present disclosure belongs to the field of display technology, and particularly relates to a display substrate, a display panel and a driving method thereof.

### BACKGROUND

A liquid crystal display (LCD) panel includes a plurality of pixels arranged in an array, each pixel including sub-pixels of a plurality of colors. As the size of the liquid crystal display panel increases, the difficulty in charging each sub-pixel of the liquid crystal display panel also increases. If the sub-pixels are not charged sufficiently, brightness corresponding to the required display gray scale cannot be achieved.

### SUMMARY

In one aspect, the present disclosure provides a display substrate including: a plurality of sub-pixels arranged in an array, the plurality of sub-pixels including sub-pixels of at least two colors, wherein for any two adjacent rows in the array, a color of the i-th sub-pixel in one row is the same as a color of the (i+1)-th sub-pixel in the other row, a color of the n-th sub-pixel in the one row is the same as a color of the first sub-pixel in the other row, where i is an integer greater than or equal to 1 and smaller than or equal to n, and n is a number of the sub-pixels in one row; and a plurality of data lines, each of which is coupled to sub-pixels of a same color in two adjacent columns of sub-pixels.

According to an embodiment of the present disclosure, any adjacent two of the plurality of data lines are configured to provide signals of opposite polarities.

According to an embodiment of the present disclosure, arrangement of the sub-pixels in each odd-numbered row is the same, and arrangement of the sub-pixels in each even-numbered row is the same.

According to an embodiment of the present disclosure, each row in the array includes a plurality of pixels arranged in sequence, and each pixel is composed of three sub-pixels of different colors.

According to an embodiment of the present disclosure, the sub-pixels in each pixel in each odd-numbered row are arranged in an order of a blue sub-pixel, a red sub-pixel, and a green sub-pixel; the sub-pixels in each pixel in each even-numbered row are arranged in an order of a red sub-pixel, a green sub-pixel, and a blue sub-pixel.

According to an embodiment of the present disclosure, the display substrate further includes a plurality of gate lines, and each gate line is coupled to one row of sub-pixels.

According to an embodiment of the present disclosure, one data line is between every two columns of sub-pixels, and is respectively coupled to the sub-pixel in an odd-numbered row and in one column of sub-pixels on one side of the data line and the sub-pixel in an even-numbered row and in one column of sub-pixels on the other side of the data line.

According to an embodiment of the present disclosure, one gate line is between every two rows of sub-pixels, and is coupled to one row of sub-pixels in two rows of sub-pixels on two sides of the gate line.

According to an embodiment of the present disclosure, the display substrate is one of a liquid crystal display substrate and an organic light emitting diode display substrate.

In another aspect, the present disclosure provides a display panel including the display substrate according to the present disclosure.

In another aspect, the present disclosure provides a method for driving a display panel, wherein the display panel is the display panel according to the present disclosure, and the method includes:

sequentially supplying an active signal to a plurality of gate lines of the display panel, and while supplying the active signal to any of the gate lines, supplying, to the plurality of data lines, data signals for the sub-pixels corresponding to the gate line.

According to an embodiment of the present disclosure, while supplying the active signal to any of adjacent gate lines, a turn-off signal is supplied to each data line coupled to the sub-pixel of at least one color, and a display signal is supplied to each data line coupled to the sub-pixel of the remaining color.

According to an embodiment of the present disclosure, the display panel is a liquid crystal display panel, and signals with opposite polarities are supplied to any two adjacent data lines.

### BRIEF DESCRIPTION OF THE DRAWINGS

FIG. 1 is a schematic structural diagram of a display substrate;

FIG. 2a is a schematic structural diagram of the display substrate shown in FIG. 1 in a case where blue sub-pixels are turned off;

FIG. 2b is a schematic diagram of signals of part of data lines of the display substrate shown in FIG. 1 in a case where the blue sub-pixels are turned off;

FIG. 3 is a schematic structural diagram of a display substrate according to an embodiment of the present disclosure;

FIG. 4a is a schematic structural diagram of a display substrate according to an embodiment of the present disclosure in a case where blue sub-pixels are turned off; and

FIG. 4b is a schematic diagram of signals of part of data lines of a display substrate according to an embodiment of the present disclosure in a case where blue sub-pixels are turned off.

### DETAILED DESCRIPTION

The present disclosure will be described in more detail below with reference to the accompanying drawings. Like elements are denoted by like reference numerals throughout the drawings. For purpose of clarity, the various features in the drawings are not drawn to scale. Moreover, certain well-known elements may not be shown in the drawings.

Numerous specific details of the present disclosure, such as structures, materials, dimensions, processes and techniques of the components, are set forth in the following description in order to provide a more thorough understanding of the present disclosure. However, as will be understood by those skilled in the art, the present disclosure may be practiced without these specific details.

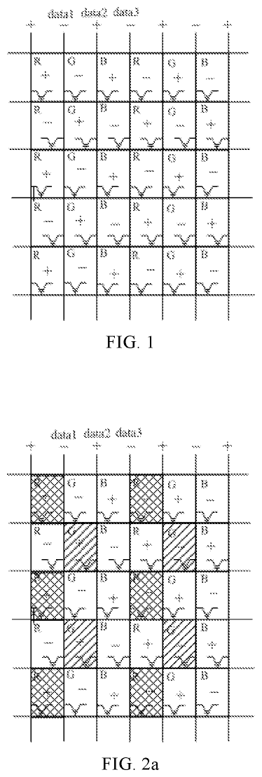

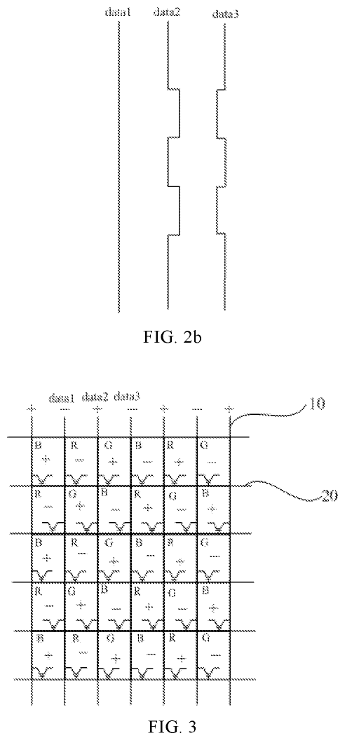

FIG. 1 is a schematic structural diagram of a display substrate, FIG. 2a is a schematic structural diagram of the display substrate shown in FIG. 1 in a case where blue sub-pixels are turned off, and FIG. 2b is a schematic diagram of signals of part of data lines of the display substrate shown in FIG. 1 in a case where the blue sub-pixels are turned off. As shown in FIG. 1, FIG. 2a and FIG. 2b, the colors of the sub-pixels in the same column of the display panel are the same, the colors of the sub-pixels in adjacent columns of the display panel are different, and each data line is coupled to the sub-pixels in odd-numbered rows and in one column on one side of the data line and the sub-pixels in even-numbered rows and in the other column on the other side of the data line.

With the display panel, as long as the polarities of data signals supplied to two adjacent data lines are opposite during the display of each frame, the liquid crystal display panel can be driven in a dot inversion mode without frequently changing the signals supplied through the data lines. It can be understood that the dot inversion mode means that when displaying one frame, the voltage polarity of each sub-pixel is opposite to the voltage polarity of four neighboring sub-pixels. When the liquid crystal display panel is driven in the dot inversion mode, the problems such as flicker and crosstalk of the liquid crystal display panel are minimized, and the display effect is optimized.

In the display panel, if a picture lacking at least one color is to be displayed, the columns of the sub-pixels of the color are turned off. Thus, it is possible that in two columns of sub-pixels coupled to the same data line, one column of sub-pixels are turned off and the other column of sub-pixels are not turned off, and in this case, the signal of the data line needs to be constantly switched between a display signal and a turn-off signal, as shown in FIG. 2b. However, the voltage difference between the display signal and the turn-off signal is relatively large, so a long time is required for switching between the display signal and the turn-off signal, which may cause insufficient charging of the non-turned-off sub-pixels by the data line, and insufficient brightness of the non-turned-off sub-pixels, and further cause abnormal pictures. This is especially true for large-sized liquid crystal display panels with high resolution.

For example, in FIG. 2a and FIG. 2b, the shaded sub-pixels represent sub-pixels with insufficient brightness. It is assumed that the liquid crystal display panel only includes red sub-pixels R, green sub-pixels G and blue sub-pixels B, a data line data3 coupled to a blue sub-pixel B in an even-numbered row is also coupled to a red sub-pixel R in an odd-numbered row at the same time, and a data line data2 coupled to a blue sub-pixel B in an odd-numbered row is also coupled to a green sub-pixel G in an even-numbered row at the same time. When the display picture does not include blue color, the brightness of the green sub-pixel G in the even-numbered row is insufficient (the sub-pixels in the row are reddish), the brightness of the red sub-pixel R in the odd-numbered row is insufficient (the sub-pixels in the row are greenish), and as a result the entire display picture will have fine streak defects.

Accordingly, the present disclosure provides, inter alia, a display panel, a display device, and a driving method that substantially obviate one or more of the problems due to limitations and disadvantages of the related art.

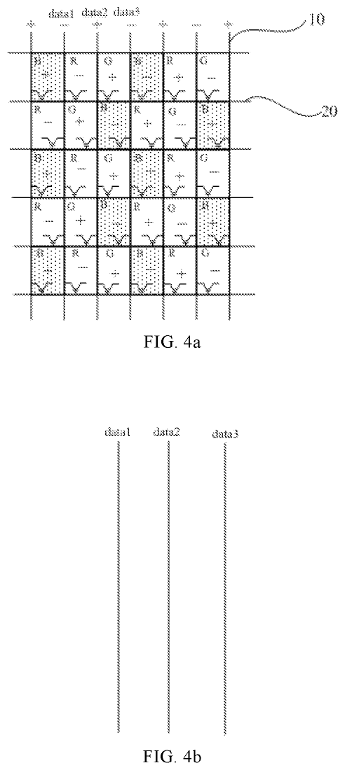

FIG. 3 is a schematic structural diagram of a display substrate according to an embodiment of the present disclosure, FIG. 4a is a schematic structural diagram of a display substrate according to an embodiment of the present disclosure in a case where blue sub-pixels are turned off, and FIG. 4b is a schematic diagram of signals of part of data lines of a display substrate according to an embodiment of the present disclosure in a case where blue sub-pixels are turned off. The shaded sub-pixels in FIG. 4a are sub-pixels that are turned off.

An embodiment of the present disclosure provides a display substrate including a plurality of sub-pixels arranged in an array, and the plurality of sub-pixels include sub-pixels of at least two colors. For any two adjacent rows in the array, a color of the i-th sub-pixel in one row is the same as a color of the (i+1)-th sub-pixel in the other row, a color of the n-th sub-pixel in the one row is the same as a color of the first sub-pixel in the other row, where i is an integer greater than or equal to 1 and less than or equal to n (i.e., 1≤i≤n), and n is the number of the sub-pixels in one row. According to the embodiment of the present disclosure, the display substrate further includes a plurality of data lines, and each data line is coupled to sub-pixels of a same color in two adjacent columns of sub-pixels.

In the display panel according to the embodiment of the present disclosure, in a row direction, any two adjacent sub-pixels have different colors; in a same column of sub-pixels, sub-pixels of two colors are alternately arranged.

As shown in FIG. 3, the display panel includes a plurality of gate lines 20 and a plurality of data lines 10, each gate line 20 is coupled to one row of sub-pixels, and each data line 10 is coupled to sub-pixels of a same color in two adjacent columns of sub-pixels.

In the present disclosure, since for any two adjacent rows in the sub-pixel array, the color of the i-th sub-pixel in one row is the same as the color of the (i+1)-th sub-pixel in the other row, and the color of the n-th sub-pixel in the one row is the same as the color of the first sub-pixel in the other row, when each data line 10 is coupled to the sub-pixels of the same color in two adjacent columns of sub-pixels, each data line 10 may be alternately coupled to the sub-pixels in two columns (i.e., coupled to the sub-pixels in the odd-numbered rows and in one of the two columns and the sub-pixels in the even-numbered rows and in the other of the two columns). As such, sub-pixels adjacent in the row direction or the column direction are coupled to different data lines 10. Therefore, as long as the polarities of the signals provided through any two adjacent data lines 10 are opposite when displaying one frame, the dot inversion driving of the liquid crystal display panel including the display substrate can be realized without frequently switching the polarities of the signals provided through the data lines 10.

In the display substrate of the present embodiment, each data line 10 is coupled to sub-pixels of a same color. If a picture lacking at least one color is to be displayed, each data line 10 coupled to the sub-pixel of the color always receives the turn-off signal, and each data line 10 coupled to the sub-pixels of other color(s) always receives the display signal. This can ensure that there is no significant change in the signal received by each data line 10, i.e., the voltage provided through the data line 10 is constant or not much different (as shown in FIG. 4b). Therefore, the problem that the signal received by the same data line is constantly switched between the display signal and the turn-off signal (i.e., the voltage supplied by the same data line 10 is changed significantly) to cause insufficient charging of some sub-pixels due to the fact that the same data line 10 is coupled to the sub-pixels of different colors can be avoided, that is, the fine streak defects of the display picture are prevented.

In an embodiment of the present disclosure, any adjacent two of the plurality of data lines are configured to supply signals of opposite polarities.

In an embodiment of the present disclosure, the arrangement of the sub-pixels in each odd-numbered row is the same, and the arrangement of the sub-pixels in each even-numbered row is the same.

In an embodiment of the present disclosure, the plurality of sub-pixels include sub-pixels of three colors. In some embodiments, the three colors are red (R), green (G), and blue (B), respectively.

In an embodiment of the present disclosure, each row in the array includes a plurality of pixels sequentially arranged, each pixel consisting of three sub-pixels of different colors. In some embodiments, the arrangement of the sub-pixels in each pixel in each odd-numbered row is the same, the arrangement of the sub-pixels in each pixel in each even-numbered row is the same, and the arrangement of the sub-pixels in each pixel in the odd-numbered row is different from the arrangement of the sub-pixels in each pixel in the even-numbered row.

For example, the sub-pixels of each pixel in the odd-numbered rows are arranged in the order of a blue sub-pixel B, a red sub-pixel R, and a green sub-pixel G; the sub-pixels of each pixel in the even-numbered rows are arranged in the order of a red sub-pixel R, a green sub-pixel G, and a blue sub-pixel B.

In addition, the plurality of sub-pixels may also include sub-pixels of two colors, four colors (e.g., red R, green G, blue B, white W), or more colors.

In the embodiment of the present disclosure, each sub-pixel includes a thin film transistor (TFT) having a gate electrode coupled to the gate line 20 and a source electrode coupled to the data line 10.

The thin film transistors electrically coupled to the gate line 20 are turned on by applying a sufficient voltage to the gate line 20 in the row direction, so that the driving signals on the data lines 10 can be written into the sub-pixels including the thin film transistors to control the sub-pixels to display or be turned off, thereby displaying a picture.

In an embodiment of the present disclosure, one data line 10 is distributed between every two columns of sub-pixels, and the data line 10 is respectively coupled to the sub-pixels in the odd-numbered rows and in one column of sub-pixels located at one side of the data line 10 and the sub-pixels in the even-numbered rows and in the other column of sub-pixels located at the other side of the data line 10.

Thus, each data line 10 is positioned between two columns of sub-pixels coupled thereto, so that the distance between each data line 10 and the sub-pixel coupled thereto is the shortest.

Such arrangement of the data line 10 can shorten the transmission distance of signals between the data line 10 and the sub-pixels as much as possible, and can further ensure that each sub-pixel is sufficiently charged, thereby ensuring the normal brightness of the display picture.

In an embodiment of the present disclosure, a gate line 20 is distributed between every two rows of sub-pixels, and the gate line 20 is coupled to one row of sub-pixels in two rows of sub-pixels on both sides thereof.

Thus, each gate line 20 is positioned at one side of one row of sub-pixels coupled thereto, so that the distance between each gate line 20 and the sub-pixel coupled thereto is the shortest.

Such arrangement of the gate line 20 can shorten the transmission distance of signals between the gate line 20 and the sub-pixel as much as possible, and can further ensure that each sub-pixel is sufficiently charged, thereby ensuring the normal brightness of the display picture.

In an embodiment of the present disclosure, the display substrate is a liquid crystal display substrate or an organic light emitting diode display substrate.

It should be noted that, if the display substrate is an organic light emitting diode display substrate, there is no dot inversion driving mode for the display substrate, that is, the polarities of the signals provided through the data lines 10 are the same, but the sub-pixels of the organic light emitting diode display substrate may still have the above arrangement.

In addition, the arrangement of the sub-pixels and the connection between the sub-pixels and the data lines 10 may be applied to a partial structure of the display substrate, or may be applied to the entire display substrate.

In another aspect, the present disclosure also provides a display panel including the display substrate according to the present disclosure.

In the display panel according to the present disclosure, each data line is coupled to sub-pixels of a same color. If a picture lacking at least one color is to be displayed, each data line coupled to the sub-pixels of the color always receives the turn-off signal, and each data line coupled to the sub-pixels of the remaining color(s) always receives the display signal. This can ensure that there is no significant change in the signal received by each data line 10, i.e., the voltage provided through the data line 10 is constant or not much different (as shown in FIG. 4b). Therefore, the problem that the signal received by the same data line is constantly switched between the display signal and the turn-off signal (i.e., the voltage supplied by the same data line 10 is changed significantly) to cause insufficient charging of some sub-pixels due to the fact that the same data line 10 is coupled to the sub-pixels of different colors can be avoided, that is, the fine streak defects of the display picture are prevented.

In addition, the arrangement of the sub-pixels and the connection between the sub-pixels and the data lines may be applied to a partial structure of the display panel, or may be applied to the entire display panel.

In the present disclosure, the display panel may be any product or component having a display function, such as a liquid crystal display panel, an organic light emitting diode (OLED) display panel, an electronic paper, a mobile phone, a tablet computer, a television, a display, a notebook computer, a digital photo frame, a navigator, and the like.

In another aspect, the present disclosure also provides a driving method of a display panel, the display panel being a display panel according to the present disclosure, and the method including:

sequentially supplying an active signal to a plurality of gate lines 20, and when the active signal is supplied to any gate line 20, supplying data signals for respective sub-pixels corresponding to the gate line 20 to the data lines 10.

In an embodiment of the present disclosure, when an active signal is supplied to any of adjacent gate lines 20, a turn-off signal is supplied to the data lines 10 coupled to the sub-pixels of at least one color, and a display signal is supplied to the data lines 10 coupled to the sub-pixels of the remaining colors.

In the driving method of the display panel according to the present embodiment, each data line 10 is coupled to the sub-pixels of a same color. If a picture lacking at least one color is to be displayed in a partial area of the display panel (or displayed in the entire area of the display panel), each data line 10 coupled to the sub-pixel of the color always receives the turn-off signal, and each data line 10 coupled to the sub-pixel of the remaining color(s) always receives the display signal. This can ensure that there is no significant change in the signal received by each data line 10, i.e., the voltage provided through the data line 10 is constant or not much different. Therefore, the problem that the signal received by the same data line is constantly switched between the display signal and the turn-off signal (i.e., the voltage supplied by the same data line 10 is changed significantly) to cause insufficient charging of some sub-pixels due to the fact that the same data line 10 is coupled to the sub-pixels of different colors can be avoided, that is, the fine streak defects of the display picture are prevented.

In the embodiment of the present disclosure, the display panel is a liquid crystal display panel, and signals with opposite polarities are supplied to any two adjacent data lines 10 to drive the display panel in the dot inversion mode.

It should be noted that, relational terms used herein such as first, second, and the like are used solely to distinguish one entity or action from another entity or action without necessarily requiring or implying any actual relationship or order between such entities or actions. Also, the terms “include”, “comprise”, or any other variations thereof, are intended to cover a non-exclusive inclusion, so that a process, method, article, or apparatus that includes a list of elements does not include only those elements but may include other elements not expressly listed or elements inherent to such process, method, article, or apparatus. Without further limitation, an element defined by the phrase “including an . . . ” does not exclude the presence of other identical elements in the process, method, article, or apparatus that includes the element.

The embodiments of the present disclosure are described above, and are not intended to be exhaustive or to limit the disclosure to the precise embodiments described. Obviously, many modifications and variations are possible in light of the above teaching. The embodiments were chosen and described in order to best explain the principle and practical application of the present disclosure, to thereby enable others skilled in the art to best utilize the present disclosure and various embodiments with various modifications as are suited to the particular use contemplated. The present disclosure is to be limited only by the claims and their full scope and equivalents.

1. A display substrate, comprising:
a plurality of sub-pixels arranged in an array, the plurality of sub-pixels comprising sub-pixels of at least two colors, wherein for any two adjacent rows in the array, a color of the i-th sub-pixel in one row is the same as a color of the (i+1)-th sub-pixel in the other row, a color of the n-th sub-pixel in the one row is the same as a color of the first sub-pixel in the other row, where i is an integer greater than or equal to 1 and smaller than or equal to n, and n is a number of the sub-pixels in one row; and
a plurality of data lines, each of which is coupled to sub-pixels of a same color in two adjacent columns of sub-pixels.

2. The display substrate of claim 1, wherein any adjacent two of the plurality of data lines are configured to provide signals of opposite polarities.

3. The display substrate of claim 1, wherein arrangement of the sub-pixels in each odd-numbered row is the same, and arrangement of the sub-pixels in each even-numbered row is the same.

4. The display substrate of claim 3, wherein each row in the array comprises a plurality of pixels arranged in sequence, and each pixel is composed of three sub-pixels of different colors.

5. The display substrate of claim 4, wherein the sub-pixels in each pixel in each odd-numbered row are arranged in an order of a blue sub-pixel, a red sub-pixel, and a green sub-pixel; the sub-pixels in each pixel of in each even-numbered row are arranged in an order of a red sub-pixel, a green sub-pixel, and a blue sub-pixel.

6. The display substrate of claim 1, further comprising a plurality of gate lines, and each gate line is coupled to one row of sub-pixels.

7. The display substrate of claim 1, wherein one data line is between every two columns of sub-pixels, and is respectively coupled to the sub-pixel in an odd-numbered row and in one column on one side of the data line and the sub-pixel in an even-numbered row and in one column on the other side of the data line.

8. The display substrate of claim 6, wherein one gate line is between every two rows of sub-pixels, and is coupled to one row of sub-pixels in two rows of sub-pixels on two sides of the gate line.

9. The display substrate of claim 1, wherein the display substrate is one of a liquid crystal display substrate and an organic light emitting diode display substrate.

10. A display panel, comprising a display substrate, wherein the display substrate is the display substrate of claim 1.

11. A method of driving a display panel, wherein the display panel is the display panel of claim 10, and the method comprises:
sequentially supplying an active signal to a plurality of gate lines of the display panel, and while supplying the active signal to any of the gate lines, supplying, to the plurality of data lines, data signals for the sub-pixels corresponding to the gate line.

12. The method of claim 11, wherein while supplying the active signal to any of adjacent gate lines, a turn-off signal is supplied to each data line coupled to the sub-pixel of at least one color, and a display signal is supplied to each data line coupled to the sub-pixel of the remaining color.

13. The method of claim 11, wherein the display panel is a liquid crystal display panel, and signals with opposite polarities are supplied to any two adjacent data lines.
